(19) United States
(12) Patent Application Publication
(10) Pub. No.: US 2009/0136841 A1
(43) Pub. Date: May 28, 2009

(54) HERMETICALLY SEALED BATTERY

(76) Inventors: Osamu WATANABE, Osaka (JP); Fusaji KITA, Osaka (JP)

Correspondence Address: BIRCH STEWART KOLASCH & BIRCH, PO BOX 747, FALLS CHURCH, VA, 22040-0747, US

(21) Appl. No.: 12/275,043

(22) Filed: Nov. 20, 2008

(30) Foreign Application Priority Data
Nov. 22, 2007 (JP) 2007-303574

(51) Int. Cl. H01M 2/08

(52) U.S. Cl. 429/174

(57) ABSTRACT

To provide a hermetically sealed battery having a seal that also serves as a terminal plate, in which the seal can be reliably welded to a battery case without causing spatters and the like while ensuring good weld strength of a lead to the seal.

A seal 17 is constituted by an aluminum layer 25 that is made of aluminum or the like and is disposed on a battery case 6 side and a dissimilar metal layer 26 having less thermal conductivity than the aluminum layer 25 and is formed on the aluminum layer 25. The aluminum layer 25 has a larger size than the dissimilar metal layer 26, and an outer peripheral edge portion 25a of the aluminum layer 25 protrudes outward beyond an outer peripheral edge 26a of the dissimilar metal layer 26. The seal 17 is welded to the battery case 6 in a state where the central axis S of a laser beam 27 moves along an outer peripheral edge 25b of the aluminum layer 25 and an edge 29a of a welding mark 29 due to irradiation with the laser beam 27 on the dissimilar metal layer 26 side is positioned outside the outer peripheral edge 26a of the dissimilar metal layer 26.

### BACKGROUND OF THE INVENTION

1. Field of the Invention

The present invention relates to a hermetically sealed battery in which a liquid injection hole is formed in a battery case at least the exterior side of which is formed of aluminum or an aluminum alloy, an electrolyte solution is injected into the battery case through the liquid injection hole, the liquid injection hole is then blocked with a seal, and in this state, the seal is welded to a portion around the liquid injection hole in the battery case by a laser beam.

2. Description of Related Art

In the hermetically sealed battery according to the present invention, the liquid injection hole, which is formed in the battery case and through which the electrolyte solution is injected, is sealed with the seal, which also serves as a terminal plate. Similar configurations are also disclosed in, for example, JP 2003-317703A (FIGS. 2 and 3) and JP 2006-12829A (FIGS. 2a to 3).

In this type of hermetically sealed battery, a lead that is joined to the terminal plate by welding is formed of nickel, a nickel alloy, or the like having excellent corrosion resistance, whereas the battery case is formed of aluminum, an aluminum alloy, or the like.

However, aluminum or an aluminum alloy cannot be considered to have good welding compatibility with nickel, a nickel alloy, or the like, and when the entire seal is formed of aluminum or the like, the weld strength of the lead is disadvantageously decreased.

To address this problem, in JP 2003-317703A and JP 2006-12829A, the seal is formed of a clad material in which a nickel layer is joined to the upper side of an aluminum layer, and the aluminum layer side is welded to the battery case and the lead is welded to the upper surface of the nickel layer.

In the hermetically sealed batteries described in JP 2003-317703A and JP 2006-12829A, the upper surface of the aluminum layer of the seal is entirely covered with the nickel layer (see FIG. 3 of JP 2006-12829A). For this reason, the seal cannot be welded to the battery case unless a laser beam is irradiated onto the nickel layer to melt the nickel layer and the aluminum layer, and the energy of the laser beam needs to be set to a high enough level to melt the nickel layer and the aluminum layer.

However, when the energy of the laser beam is set to a high level, the temperature of the nickel layer is elevated. Consequently, the nickel layer is melted and evaporated, resulting in the occurrence of so-called spatters, that is, spattering of the nickel layer. Therefore, in the hermetically sealed batteries of JP 2003-317703A and JP 2006-12829A, there is a risk that welding defects, such as pinholes, associated with the occurrence of spatters may occur and lead to a decrease in the weld strength.

### SUMMARY OF THE INVENTION

The present invention has been conceived to solve the problems as described above with a conventional hermetically sealed battery provided with a seal that also serves as a terminal plate, and it is an object thereof to provide a hermetically sealed battery in which the seal can be reliably welded to the battery case without causing spatters and the like while ensuring good weld strength of the lead to the seal.

In order to achieve this object, the hermetically sealed battery of the present invention is a hermetically sealed battery having a battery case at least the exterior side of which is formed of aluminum or an aluminum alloy and a seal that seals a liquid injection hole that is formed in the battery case and used to inject an electrolyte solution, the seal being welded to a portion around the liquid injection hole in the battery case by a laser beam, wherein the seal is constituted by an aluminum layer that is made of aluminum or an aluminum alloy and is disposed on the battery case side and a dissimilar metal layer that is made of a metal or a metal alloy having less thermal conductivity than the aluminum layer and is formed on the aluminum layer; the aluminum layer has a larger size than the dissimilar metal layer, and an outer peripheral edge portion of the aluminum layer protrudes outward beyond an outer peripheral edge of the dissimilar metal layer; and the seal is welded to the battery case in a state where an edge of a welding mark due to irradiation with the laser beam on the dissimilar metal layer side is positioned outside the outer peripheral edge of the dissimilar metal layer.

Specific examples of the dissimilar metal include metals such as nickel and stainless steel. The state in which the edge of the welding mark on the dissimilar metal layer side is positioned outside the outer peripheral edge of the dissimilar metal layer includes a case where the position of the edge of the welding mark coincides with the outer peripheral edge of the dissimilar metal layer.

### BRIEF DESCRIPTION OF THE DRAWINGS

FIG. 1 is a vertical sectional front view of a hermetically sealed battery according to the present invention.

FIG. 2 is an enlarged cross-sectional view of a relevant part of a seal.

FIG. 3 is an exploded perspective view of the hermetically sealed battery.

FIG. 4 is a plan view showing a state in which a lead is connected to the hermetically sealed battery.

### DETAILED DESCRIPTION OF THE INVENTION

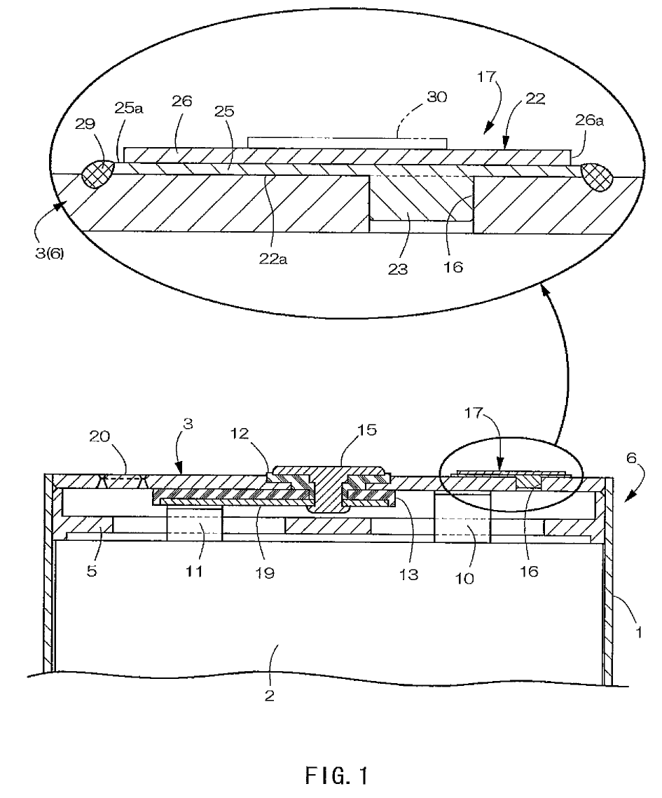

As shown in FIGS. 1 to 3, according to a hermetically sealed battery of the present invention, an outer peripheral edge portion 25a of an aluminum layer 25 of a seal 17 protrudes outward beyond an outer peripheral edge 26a of a dissimilar metal layer 26, so that a laser beam 27 can be directly irradiated onto the aluminum layer 25.

Therefore, the need to melt the dissimilar metal layer 26 is eliminated, and the aluminum layer 25 can be reliably welded to a battery case 6 while reducing the irradiation energy of the laser beam 27 to a low level.

Since a lead 30 can be welded onto the dissimilar metal layer 26 formed of nickel, stainless steel, or the like, good weld strength of the lead 30 can also be ensured. The seal, which is given the function of the terminal plate, reduces the number of components and can also contribute to a reduction in the manufacturing cost of the hermetically sealed battery.

In addition, since the seal 17 is welded by the laser beam 27 so that an edge 29a of a welding mark 29 is positioned outside the outer peripheral edge 26a of the dissimilar metal layer 26, the occurrence of so-called spatters, that is, melting and spattering of the dissimilar metal layer 26 can be prevented, and thus the occurrence of welding defects can also be reliably prevented.

Specifically, since the aluminum layer 25 has greater thermal conductivity than the dissimilar metal layer 26, the aluminum layer 25 easily diffuses heat generated by the laser beam 27. For this reason, the irradiation energy of the laser beam 27 is set to a higher level than in the case where, for example, nickel is welded. Thus, when the heat generated by the laser beam 27 at such a high energy is transmitted to the dissimilar metal layer 26, the temperature of the dissimilar metal layer 26 is elevated accordingly because the dissimilar metal layer 26 does not easily diffuse heat. Consequently, the dissimilar metal layer 26 is melted and evaporated, resulting in the occurrence of spatters.

In contrast, in the present invention, since the edge 29a of the welding mark 29 is positioned outside the outer peripheral edge 26a of the dissimilar metal layer 26 as described above, the heat generated by the laser beam 27 is not easily transmitted to the dissimilar metal layer 26, so the occurrence of spatters can be effectively prevented. Therefore, welding defects, such as pinholes, associated with the occurrence of spatters are prevented, and the seal 17 can be reliably fixed to the battery case 6 by welding.

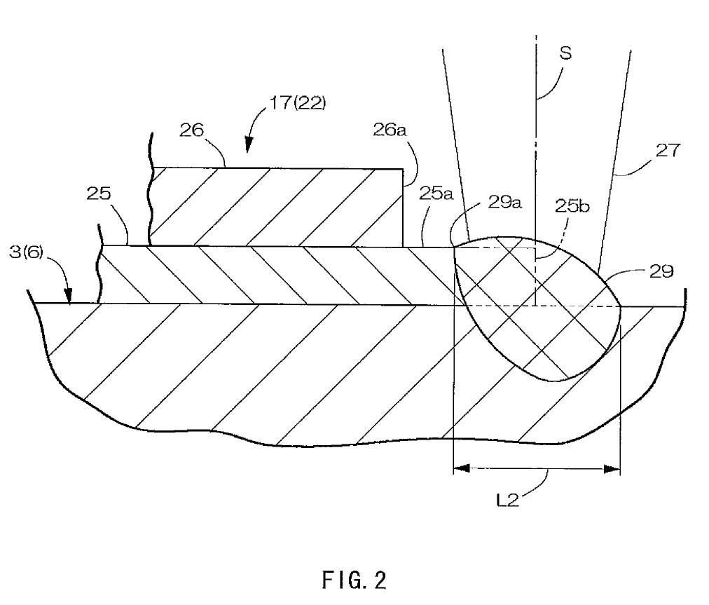

In the above-described hermetically sealed battery of the present invention, it is preferable that the seal is welded in a state where the central axis of the laser beam coincides with an outer peripheral edge of the aluminum layer. With this configuration, in FIG. 2, the laser beam 27 is reliably irradiated onto the outer peripheral edge portion 25a of the aluminum layer 25, and the laser beam 27 is also irradiated onto the battery case 6 in the vicinity of the outer peripheral edge 25a of the aluminum layer 25. Thus, the outer peripheral edge portion 25a of the aluminum layer 25 and the battery case 6 can be reliably melted by the irradiation energy of the laser beam 27, and consequently, the seal 17 can be reliably welded to the battery case 6.

Moreover, it is preferable that the seal has a shaft section that is formed integrally with the aluminum layer and that projects downward from a lower surface of the aluminum layer, the shaft section being inserted into the liquid injection hole. With this configuration, as shown in FIG. 1, the seal 17 is reliably positioned in the battery case 6 by the shaft section 23. Therefore, the liquid injection hole 16 can be reliably blocked with the seal 17, and in addition, the seal 17 can be reliably welded to a portion around the liquid injection hole 16 even when an automatic welder is used. Moreover, since the shaft section 23 is inserted into the liquid injection hole 16, the liquid injection hole 16 can be more reliably sealed with the seal 17.

Moreover, it is preferable that the position of the edge of the welding mark on the dissimilar metal layer side is an average of 0.1 mm or more to the outside of the position of the outer peripheral edge of the dissimilar metal layer. This configuration is more advantageous for preventing the occurrence of welding defects associated with the occurrence of spatters.

Moreover, it is preferable that the position of the edge of the welding mark on the dissimilar metal layer side is 1 mm or less from the position of the outer peripheral edge of the dissimilar metal layer. With this configuration, the protruding dimension of the aluminum layer can be reduced. Thus, the outer peripheral edge of the aluminum layer can be prevented from being too close to a negative terminal electrode and an insulating packing, and pressing is also facilitated.

Moreover, it is preferable that the outer peripheral edge portion of the aluminum layer protrudes outward beyond the outer peripheral edge of the dissimilar metal layer by 0.1 mm or more. With this configuration, the welding mark can be formed only in the outer peripheral edge portion of the aluminum layer, so that the welding mark can be prevented from reaching the dissimilar metal layer.

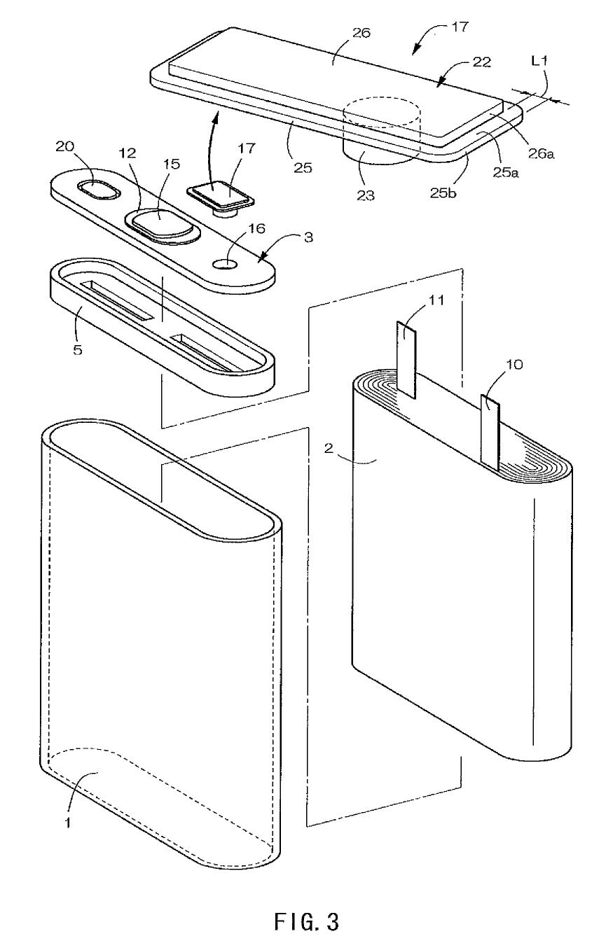

As shown in FIGS. 1 and 3, a hermetically sealed battery according to the present invention includes a battery can 1 that has the shape of a closed-bottom rectangular tube having in its upper surface a horizontally elongated opening extending in the right-to-left direction, an electrode body 2 and a nonaqueous electrolyte solution that are contained in the battery can 1, a horizontally elongated lid 3 that extends in the right-to-left direction and blocks the upper face of the opening in the battery case 1 for hermetically sealing, and a plastic insulator 5 that is disposed inside the lid 3. The battery can 1 has a width of 34 mm in the right-to-left direction, a height of 46 mm in the top-to-bottom direction, and a thickness of 4 mm in the front-to-rear direction. The battery can 1 and the lid 3 form a battery case 6.

The electrode body 2 is prepared by spirally winding a band-like positive electrode and a band-like negative electrode with a band-like separator interposed between each other. As shown in FIG. 3, the electrode body 2 has a flat shape in the wound state. In the positive electrode, a positive electrode active material layer containing a positive electrode active material such as lithium cobalt oxide is formed on both of the front and back surfaces of a band-like positive electrode collector, and as shown in FIGS. 1 and 3, a sheet-like, positive electrode collecting lead 10 extends from the positive electrode collector.

In the negative electrode, a negative electrode active material layer containing a negative electrode active material such as graphite is formed on both of the front and back surfaces of a band-like negative electrode collector, and a sheet-like, negative electrode collecting lead 11 extends from the negative electrode collector. The separator is formed of, for example, a microporous thin film made of a polyethylene resin or the like. The nonaqueous electrolyte solution is prepared by dissolving LiPF₆ in a solvent in which ethylene carbonate and methyl ethyl carbonate are mixed.

The battery can 1 is molded by deep drawing a plate material of aluminum or an aluminum alloy. The lid 3 is molded by pressing a plate material of aluminum or an aluminum alloy, and an outer peripheral edge of the lid 3 is seam-welded to a peripheral edge of the opening in the battery can 1 by a laser beam from a YAG laser or the like. The battery case 6 shown in FIG. 1 is thus formed. A negative electrode terminal 15 is attached to and penetrates through the center of the lid 3 via an insulating packing 12 on the upper side and an insulating plate 13 on the lower side.

A liquid injection hole 16 having a circular shape when viewed from above is formed near the right edge of the lid 3 in the right-to-left direction and penetrates through the lid 3 in the top-to-bottom direction. After the nonaqueous electrolyte solution is injected into the battery case 6 through the liquid injection hole 16, the liquid injection hole 16 is blocked with a seal 17. A lead body 19 disposed on the inner surface of the lid 3 is connected to the lower end of the negative electrode terminal 15, the lead body 19 being formed of a horizontally elongated sheet extending in the right-to-left direction. The lead body 19 extends away from the liquid injection hole 16 and is insulated from the lid 3 by the insulating plate 13. The negative electrode collecting lead 11 is welded to the lower surface of the lead body 19.

The positive electrode collecting lead 10 is welded to a space between the insulating plate 13 and the liquid injection hole 16 on the back surface of the lid 3. Thus, the positive electrode collecting lead 10 is in communication with the lid 3 and the battery can 1, and the lid 3 and the battery can 1 are electrically charged to the potential of the positive electrode. A cleavage vent 20 is formed near an edge (near the left edge in FIG. 3) of the lid 3 in the right-to-left direction. When the internal pressure of the battery abnormally increases, the cleavage vent 20 cleaves and releases the internal pressure of the battery.

As shown in FIGS. 1 and 3, the seal 17 has a quadrangular plate-shaped head section 22 that is welded to a portion around the liquid injection hole 16 in the upper surface of the lid 3 and a column-shaped shaft section 23 that projects downward from a position slightly right of the center of a lower surface 22a of the head section 22.

The head section 22 of the seal 17 is constituted by an aluminum layer 25 that is made of aluminum or an aluminum alloy and a dissimilar metal layer 26 that is preferably made of nickel or a nickel alloy having less thermal conductivity than the aluminum layer 25 and that is formed on the aluminum layer 25. The shaft section 23 of the seal 17 is formed integrally with the aluminum layer 25 in the head section 22 and inserted (press-fitted) into the liquid injection hole 16 (a state shown in FIG. 1).

As shown in FIG. 3, in the head section 22 of the seal 17, the aluminum layer 25 has a larger size than the dissimilar metal layer 26, and an outer peripheral edge portion 25a of the aluminum layer 25 protrudes outward beyond an outer peripheral edge 26a of the dissimilar metal layer 26 by a protruding dimension L1 of 0.4 mm.

In other words, a clad material formed by laying a plate material made of aluminum or an aluminum alloy and a plate material made of a dissimilar metal such as nickel or a nickel alloy on top of each other and joining these plate materials by pressure welding with a rolling mill is used as the seal 17. The head section 22 is formed using a pressing machine, and the shaft section 23 is formed from a part of the plate material made of aluminum or an aluminum alloy.

Moreover, the outer peripheral edge portion 25a of the aluminum layer 25 in the head section 22 is formed to protrude outward beyond the outer peripheral edge 26a of the dissimilar metal layer 26. The aluminum layer 25 in the head section 22 has a thickness of 0.15 mm, the dissimilar metal layer 26 has a thickness of 0.2 mm, and the shaft section 23 has a thickness in the top-to-bottom direction of 1 mm.

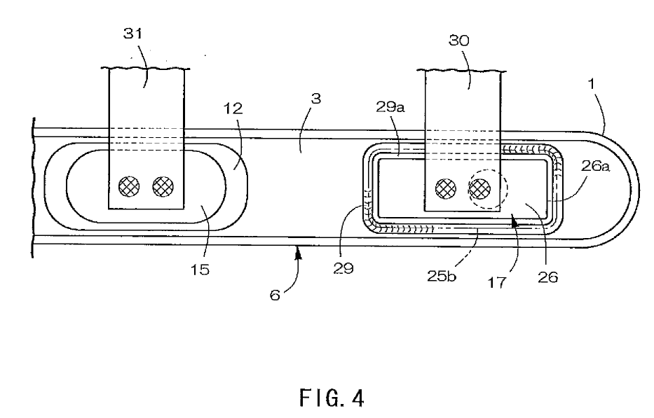

Then, the outer peripheral edge portion 25a of the aluminum layer 25 in the head section 22 is welded to a portion around the liquid injection hole 16 in the lid 3 of the battery case 6 by a laser beam 27 from a YAG laser or the like. In other words, as shown in FIGS. 2 and 4, the outer peripheral edge portion 25a of the aluminum layer 25 of the seal 17 is welded to the lid 3 of the battery case 6 in a state where the central axis S of the laser beam 27 moves along the outer peripheral edge 25b of the aluminum layer 25 in the head section 22 and an edge 29a of a welding mark 29 due to the irradiation with the laser beam 27 on the dissimilar metal layer 26 side is positioned outside the outer peripheral edge 26a of the dissimilar metal layer 26. Specifically, the seal 17 is welded in a state where the central axis S of the laser beam 27 coincides with the outer peripheral edge 25b of the aluminum layer 25 in the head section 22.

As shown in FIG. 2, the position of the edge 29a of the welding mark 29 on the dissimilar metal layer 26 side is outside the position of the outer peripheral edge 26a of the dissimilar metal layer 26. With this configuration, the occurrence of spatters, that is, melting and spattering of the dissimilar metal layer 26 due to heat generated by the laser beam 27, can be prevented, and the occurrence of welding defects, such as pinholes, associated with the occurrence of spatters can be prevented.

The edge 29a of the welding mark 29 only needs to be kept from overlapping with the dissimilar metal layer 26, and the above-described configuration in which the position of the edge 29a of the welding mark 29 is outside the position of the outer peripheral edge 26a of the dissimilar metal layer 26 includes a configuration in which the position of the edge 29a of the welding mark 29 coincides with the position of the outer peripheral edge 26a of the dissimilar metal layer 26.

On the other hand, in order to more reliably prevent the occurrence of welding defects, the position of the edge 29a of the welding mark 29 on the dissimilar metal layer 26 side is desirably an average of 0.1 mm or more and more desirably an average of 0.2 mm or more to the outside of the position of the outer peripheral edge 26a of the dissimilar metal layer 26.

Moreover, when the position of the edge 29a of the welding mark 29 on the dissimilar metal layer 26 side is too far from the outer peripheral edge 26a of the dissimilar metal layer 26, the protruding dimension L1 of the outer peripheral edge portion 25a of the aluminum layer 25 is also too large. In this configuration, the outer peripheral edge 25b of the aluminum layer 25 may be too close to the negative electrode terminal 15 and the insulating packing 12. Furthermore, a large protruding dimension L1 also results in difficulty in pressing. Therefore, the position of the edge 29a of the welding mark 29 on the dissimilar metal layer 26 side is desirably 1 mm or less from the position of the outer peripheral edge 26a of the dissimilar metal layer 26.

In order for the welding mark 29 to be formed only in the outer peripheral edge portion 25a of the aluminum layer 25 and kept from reaching the dissimilar metal layer 26, the outer peripheral edge portion 25a of the aluminum layer 25 of the seal 17 desirably protrudes outside the seal 17 beyond the outer peripheral edge 26a of the dissimilar metal layer 26 by a protruding dimension L1 of 0.1 mm or more, more desirably 0.2 mm or more, and most desirably 0.3 mm or more.

During assembly of the battery the negative electrode terminal 15, the insulating packing 12, the insulating plate 13, and the lead body 19 are each attached to the lid 3 beforehand as described above, and after the electrode body 2 and the insulator 5 are contained in the battery can 1, the negative electrode collecting lead 11 and the positive electrode collecting lead 10 are welded to the lead body 19 and the lid 3, respectively. Then, after the lid 3 is seam-welded to the peripheral edge of the opening in the battery can 1, a vacuum is created in the battery can 1, and the nonaqueous electrolyte solution is injected into the battery can 1 through the liquid injection hole 16.

After the completion of injection of the nonaqueous electrolyte solution, the shaft section 23 of the seal 17 is press-fitted into the liquid injection hole 16, and then the outer peripheral edge portion 25a of the aluminum layer 25 in the head section 22 of the seal 17 is welded to a portion around the liquid injection hole 16 by the laser beam 27 (the state shown in FIG. 1). Thus, the liquid injection hole 16 is blocked and sealed with the seal 17.

Subsequently, as shown in FIG. 4, a positive electrode lead 30 connected to a protection circuit or the like is spot-welded to the upper surface of the dissimilar metal layer 26 in the head section 22 of the seal 17, and a negative electrode lead 31 connected to the protection circuit or the like is spot-welded to the upper surface of the negative electrode terminal 15. The positive electrode lead 30 is formed of, for example, a clad material having a layer of nickel or a nickel alloy, and the nickel or nickel alloy layer is welded to the head section 22 of the seal 17.

### EXAMPLES

First, 1000 each of batteries according to Examples 1 to 3 and a comparative example as will be described below were prepared, and the batteries were then examined for the occurrence of pinholes and the occurrence of spatters. In Examples 1 to 3 and the comparative example, the protruding dimension L1 of the outer peripheral edge portion 25a of the aluminum layer 25 in the head section 22 of the seal 17 was set to 0.4 mm, and the diameter of the laser beam 27 at the irradiation position was set to 0.45 mm. Thus, the width L2 of the welding mark 29 due to irradiation with the laser beam 27 was 0.6 mm.

### Example 1

In the batteries according to Example 1, the seal 17 was welded to the lid 3 in a position in which the central axis S of the laser beam 27 was 0.1 mm closer to the nickel layer 26 side than the outer peripheral edge 25b of the aluminum layer 25 in the head section 22 of the seal 17. Thus, the position of the edge 29a of the welding mark 29 on the nickel layer 26 side coincided with the position of the outer peripheral edge 26a of the nickel layer 26.

### Example 2

In the batteries according to Example 2, the seal 17 was welded to the lid 3 in a position in which the central axis S of the laser beam 27 coincided with the outer peripheral edge 25b of the aluminum layer 25 in the head section 22 of the seal 17. Thus, the position of the edge 29a of the welding mark 29 on the nickel layer 26 side was 0.1 mm to the outside of the position of the outer peripheral edge 26a of the nickel layer 26.

### Example 3

In the batteries according to Example 3, the seal 17 was welded in a position in which the central axis S of the laser beam 27 was 0.2 mm to the outside of the outer peripheral edge 25b of the aluminum layer 25 in the head section 22 of the seal 17. Thus, the position of the edge 29a of the welding mark 29 on the nickel layer 26 side was 0.3 mm to the outside of the outer peripheral edge 26a of the nickel layer 26.

### Comparative Example

In the batteries according to the comparative example, the seal 17 was welded to the lid 3 in a position in which the central axis S of the laser beam 27 was 0.3 mm closer to the nickel layer 26 side than the outer peripheral edge 25b of the aluminum layer 25 in the head section 22 of the seal 17. Thus, the edge 29a of the welding mark 29 on the nickel layer 26 side was positioned 0.1 mm inside the outer peripheral edge 26a of the nickel layer 26, and the welding mark 29 overlapped with the nickel layer 26.

TABLE 1

| | Number of batteries in which the occurrence of |
|---|---|
| | pinholes and spatters was observed (number) |
| Example 1 | 1 |
| | (Only the occurrence of spatters was observed.) |
| Example 2 | 0 |
| Example 3 | 0 |
| Comparative Example | 10 |

As is clear from Table 1, among the batteries of Example 1, the occurrence of pinholes was observed in none of the batteries, and the occurrence of spatters was observed in only one of the batteries. Among the batteries of Examples 2 and 3, the occurrence of pinholes and the occurrence of spatters were not observed. In contrast, among the batteries of the comparative example, the occurrence of pinholes and the occurrence of spatters were observed in ten of the batteries.

Note that when the position of the central axis S of the laser beam 27 was moved further outward from the position of Example 3, the laser beam 27 no longer impinged on the outer peripheral edge portion 25a of the aluminum layer 25, and the outer peripheral edge portion 25a of the aluminum layer 25 was not welded to the lid 3.

As described above, since the outer peripheral edge portion 25a of the aluminum layer 25 in the head section 22 of the seal 17 protrudes outward beyond the outer peripheral edge 26a of the dissimilar metal layer 26, the laser beam 27 can be directly irradiated onto the aluminum layer 25, and thus the aluminum layer 25 can be reliably welded to the battery case 6.

Since the seal 17 is welded by the laser beam 27 so that the edge 29a of the welding mark 29 is positioned outside the outer peripheral edge 26a of the dissimilar metal layer 26, the occurrence of spatters, that is, melting and spattering of the dissimilar metal layer 26 due to heat generated by the laser beam 27 can be prevented, and thus the occurrence of welding defects, such as pinholes, associated with the occurrence of spatters can be prevented.

The protruding dimension L1 of the outer peripheral edge portion 25a of the aluminum layer 25 of the seal 17 can be increased. However, a protruding dimension L1 of 0.8 mm or more will result in difficulty in pressing. Moreover, the protruding dimension L1 is also limited by the size of the battery and other factors. The protruding dimension L1 is set with consideration given to these matters. As for the diameter of the laser beam 27, when the diameter is increased, the irradiation energy of the laser beam 27 needs to be increased accordingly. On the other hand, when the diameter is too small, the aluminum layer 25 is melted too deeply, resulting in a risk that spattering of the aluminum layer 25 may occur. The diameter of the laser beam 27 is set with consideration given to these matters.

The shaft section 23 of the seal 17 may also be made of synthetic rubber or the like. In this case, the shaft section 23 is fixed to the lower surface 22a of the head section 22 with an adhesive or the like. The shaft section 23 may also be inserted into the liquid injection hole 16 in a state where the shaft section 23 has some play. Moreover, the shaft section 23 may also be omitted, and the seal 17 may be formed only of the head section 22. Even in this case, the outer peripheral edge portion 25a of the aluminum layer 25 protrudes outside the seal 17 beyond the outer peripheral edge 26a of the dissimilar metal layer 26.

The liquid injection hole 16 and the seal 17 are not necessarily required to be provided in the lid 3 and can be provided in any part of the battery case 6. For example, the liquid injection hole 16 and the seal 17 may also be provided in the bottom surface or a side surface of the battery can 1.

In the seal 17, as the dissimilar metal layer 26 there may also be used in addition to nickel or nickel alloy, a metal layer made of stainless steel, a stainless alloy, or the like. The battery can 1 and the lid 3 may also be prepared using a clad material at least the exterior side of which is formed of a layer of aluminum or an aluminum alloy.

The invention may be embodied in other forms without departing from the spirit or essential characteristics thereof The embodiment disclosed in this application is to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A hermetically sealed battery comprising a battery case at least the exterior side of which is formed of aluminum or an aluminum alloy and a seal that seals a liquid injection hole that is formed in the battery case and used to inject an electrolyte solution, the seal being welded to a portion around the liquid injection hole in the battery case by a laser beam,
wherein the seal is constituted by an aluminum layer that is made of aluminum or an aluminum alloy and is disposed on the battery case side and a dissimilar metal layer that is made of a metal or a metal alloy having less thermal conductivity than the aluminum layer and is formed on the aluminum layer;
the aluminum layer has a larger size than the dissimilar metal layer, and an outer peripheral edge portion of the aluminum layer protrudes outward beyond an outer peripheral edge of the dissimilar metal layer; and
the seal is welded to the battery case in a state where an edge of a welding mark due to irradiation with the laser beam on the dissimilar metal layer side is positioned outside the outer peripheral edge of the dissimilar metal layer.

2. The hermetically sealed battery according to claim 1, wherein the seal is welded in a state where a central axis of the laser beam coincides with an outer peripheral edge of the aluminum layer.

3. The hermetically sealed battery according to claim 1, wherein the seal has a shaft section that is formed integrally with the aluminum layer and that projects downward from a lower surface of the aluminum layer, the shaft section being inserted into the liquid injection hole.

4. The hermetically sealed battery according to claim 1, wherein the position of the edge of the welding mark on the dissimilar metal layer side is an average of 0.1 mm or more to the outside of the position of the outer peripheral edge of the dissimilar metal layer.

5. The hermetically sealed battery according to claim 1, wherein the position of the edge of the welding mark on the dissimilar metal layer side is 1 mm or less from the position of the outer peripheral edge of the dissimilar metal layer.

6. The hermetically sealed battery according to claim 1, wherein the outer peripheral edge portion of the aluminum layer protrudes outward beyond the outer peripheral edge of the dissimilar metal layer by 0.1 mm or more.
